(19) United States
(12) Patent Application Publication
(10) Pub. No.: US 2006/0023874 A1
(43) Pub. Date: Feb. 2, 2006

(54) Method and multiline scrambled clock architecture with random state selection for implementing lower electromagnetic emissions

(75) Inventor: Don Alan Gilliland, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 10/901,846

(22) Filed: Jul. 29, 2004

(51) Int. Cl. H04L 9/28; H04L 9/00; H04K 1/00

(52) U.S. Cl. 380/28

(57) ABSTRACT

A method and multiple line scrambled clock architecture with random state selection are provided for implementing lower electromagnetic emissions. A clock distribution circuit receives a clock input and generates a plurality of scrambled sequences, each respectively coupled by one of a plurality of N clock distribution lines to a destination circuit. An exclusive OR connected to the N clock distribution lines unscrambles the plurality of scrambled sequences at the destination circuit. The plurality of scrambled sequences includes multiple bit clock representations, for example, 3 bit clock representations. The presence of 1s and 0s on each of the multiple N clock distribution lines is a substantially uniform distribution. The scrambled sequences are generally pseudorandom sequences.

### FIELD OF THE INVENTION

The present invention relates generally to the data processing field, and more particularly, relates to a method and multiple line scrambled clock architecture with random state selection for implementing lower electromagnetic emissions.

### DESCRIPTION OF THE RELATED ART

Clock lines typically have the highest energy in terms of electromagnetic emissions from a printed circuit board. A clock signal is a high frequency rectangular wave. The clock sequence or continuous repeating 1010 pattern result in high levels of energy being radiated at certain narrow frequency bands, while much lower energy is radiated at other frequencies. The continuous harmonic structure of the clock creates generally huge peaks in the electromagnetic emissions spectrum.

A problem exists to reduce clock signal created electromagnetic emissions or radiation without sacrificing the timing reference while maintaining low jitter. In the past, spread spectrum has been used to spread the spectral density across a wide portion of the spectrum.

U.S. Pat. No. 5,894,517, issued Apr. 19, 1999 to Hutchison et al., discloses a method and apparatus for substantially reducing electromagnetic radiation from a backplane used to interconnect multiple communication modules. Data signals to be transmitted onto the backplane are first scrambled using a pseudorandom code sequence, to reduce energy peaks in the radiation spectrum and to spread energy over a wider bandwidth. Signals received from the backplane are descrambled using an identical pseudorandom code sequence. Data rate synchronization is provided by recovery of a data clock signal from the received scrambled signals, and data frame synchronization is provided by transmitting data frame headers as non-scrambled data. At a receiver module, the frame headers are detected and used to reset the descrambling operation.

A need exists for an effective mechanism for providing a clock implementing lower electromagnetic emissions for a printed circuit board without sacrificing the timing reference and while maintaining low jitter.

### SUMMARY OF THE INVENTION

A principal aspect of the present invention is to provide a method and multiple line scrambled clock architecture with random state selection for implementing lower electromagnetic emissions. Other important aspects of the present invention are to provide such method and multiple line scrambled clock architecture substantially without negative effect and that overcome some disadvantages of prior art arrangements.

In brief, a method and multiple line scrambled clock architecture with random state selection are provided for implementing lower electromagnetic emissions. A clock distribution circuit receives a clock input and generates a plurality of scrambled sequences, each respectively coupled by one of a plurality of N clock distribution lines to a destination circuit. An exclusive OR connected to the N clock distribution lines unscrambles the plurality of scrambled sequences at the destination circuit.

In accordance with features of the invention, each of the plurality of scrambled sequences includes multiple bit clock representations, for example, 3 bit clock representations. The presence of 1s and 0s on each of the multiple N clock distribution lines is a substantially uniform distribution. The scrambled sequences are generally pseudorandom sequences.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram illustrating an exemplary multiple line scrambled clock architecture with random state selection for implementing lower electromagnetic emissions in accordance with the preferred embodiment;

FIG. 2 is an exemplary state machine diagram for a 3 line to 1 line scrambled clock architecture of FIG. 1 in accordance with the preferred embodiment; and

FIG. 3 is a timing diagram illustrating exemplary 3 line sequences to 1 line sequence for the scrambled clock architecture of FIG. 1 in accordance with the preferred embodiment; and

FIG. 4 is a schematic and block diagram illustrating an exemplary 3 line scrambled clock architecture of FIG. 1 in accordance with the preferred embodiment.

### DETAILED DESCRIPTION OF THE PREFERRED EMBODIMENTS

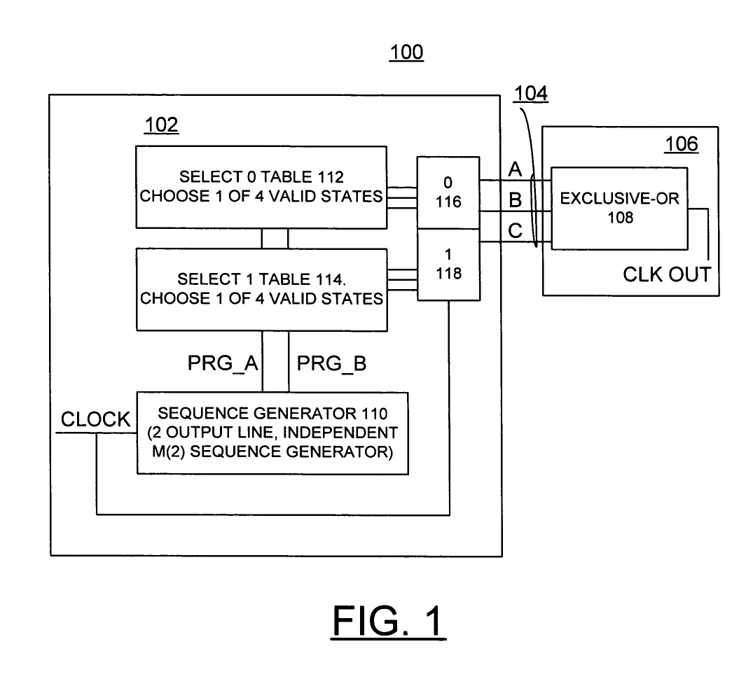

Having reference now to the drawings, in FIG. 1, there is shown an exemplary multiple line scrambled clock architecture with random state selection generally designated by the reference character 100 for implementing lower electromagnetic emissions in accordance with the preferred embodiment. The multiple line scrambled clock architecture 100 implements an N line to one line clock conversion. The multiple line scrambled clock architecture 100 includes a clock distribution circuit generally designated by the reference character 102. The clock distribution circuit 102 is coupled by a plurality of N clock distribution lines generally designated by the reference character 104 to a destination circuit 106. Three clock distribution lines 104 are shown in FIG. 1 and labeled A, B, and C, each carrying a pseudo-random sequence that are recombined to reproduce the clock at the destination circuit 106. Signals carried on the multiple N clock distribution lines 104 are recombined using an exclusive OR gate 108 to provide a single clock output labeled CLK OUT.

In accordance with features of the preferred embodiment, signals on all N lines 104 are scrambled into a pseudorandom sequence, eliminating repetitive clock patterns on the N clock distribution lines 104. The scrambled clock streams have radiated energy spread over a much broader band of frequencies, with the energy peaks of a conventional repetitive clock pattern being substantially reduced. Signals carried on the multiple N clock distribution lines 104 are transmitted in parallel form providing a coherent edge change for each clock transition and recombined at the destination circuit 106 by an exclusive OR operation of the clock distribution lines.

In accordance with features of the preferred embodiment, signals on all N lines 104 result in substantially lower electromagnetic emissions from a conventional single line clock. The disadvantage of requiring the additional N−1 clock distribution lines and loss in real estate is offset by the benefit in lowered emissions that may not be obtainable otherwise.

As shown, clock distribution circuit 102 includes a sequence generator 110, such as a 2 output line, independent m(2) sequence generator for use with three clock distribution lines 104. The sequence generator 110 receives a clock input and includes two output lines labeled PRG_A, PRG_B coupled to a select 0 table 112 and a select 1 table 114, each to choose one of four (1 of 4) valid states. The two lines of output of the sequence generator 110 are used to implement a one of four selection of 0 or 1 modes, i.e., 00, 01, 10, and 11. A 0 table select 116 and a 1 table select 118 respectively coupled to the select 0 table 112 and the select 1 table 114 receiving the clock input for choosing which one of the tables 112, 114 is used in each clock time frame.

In accordance with features of the preferred embodiment, the clock distribution circuit 102 advantageously is implemented by a simple arrangement, minimizing the overhead required. For example, the clock distribution circuit 102 can be implemented with mainly exclusive OR gates for hardware or a pseudorandom algorithm with look-up table for software. The m-sequence pseudorandom generator 110 can be implemented by shift registers with additive feedback lines to input back to the input of the shift registers.

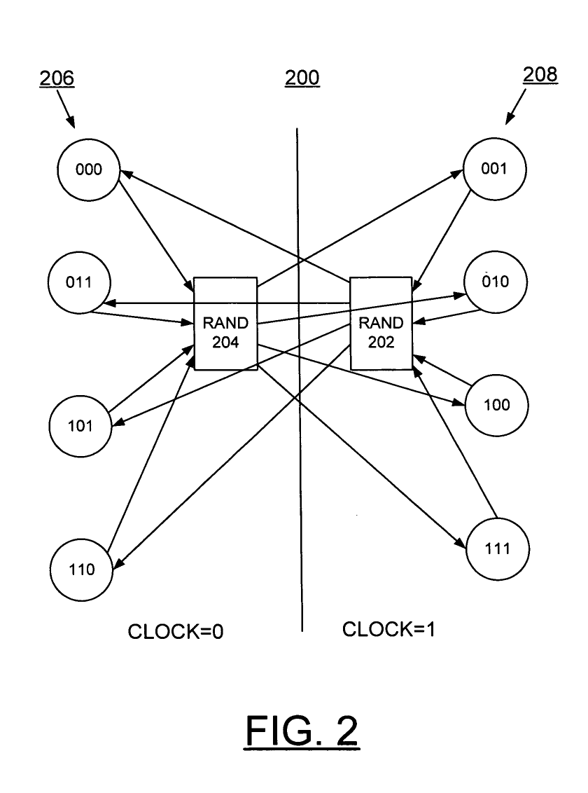

Referring also to FIG. 2, there is shown a state machine diagram generally designated by the reference character 200 for an exemplary 3 line to 1 line scrambled clock architecture 100. State machine 200 generates the N clocks where the exclusive OR of the line states determines the clock value at the destination circuit 106. This clock value alternates between a 1 and 0 to produce the CLK OUT. A pair of randomizers 202 and 204 randomly chooses a respective one of four possible 3 bits states respectively generally designated by 206 for clock 0, and 208 for clock 1. States 206 for clock 0 include 000, 011, 101, and 110 and states 208 for clock 1 include 001, 010, 100, 111.

The output clock CLK OUT in FIG. 1 alternates between a 1 and 0, while the state is randomly chosen by the respective randomizers 202 and 204 to produce a random sequence on the three clock distribution lines 104, A, B, and C. For example, if the present state is 000 then after the randomizer 204, the state 208 may be 001, 010, 100 or 111, each state 208 will produce a 1 on the output clock CLK OUT.

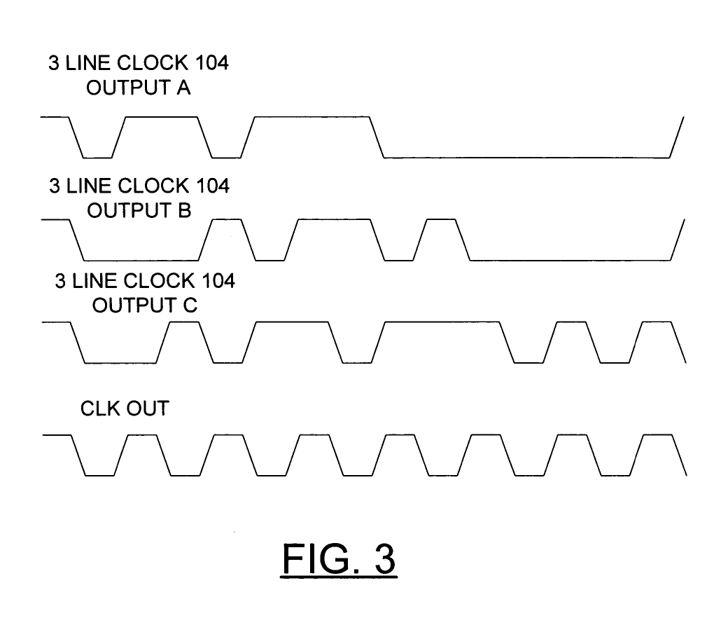

Referring also to FIG. 3, a timing diagram illustrates exemplary random sequences on the three clock distribution lines 104, A, B, and C and a resulting sequence or output clock CLK OUT of the scrambled clock architecture 100. As shown in FIG. 2, the output clock CLK OUT is a stable reproduced clock that is descrambled using the exclusive OR gate 108 of FIG. 1. The clock distribution chip 102 with the M-sequence generator 110 sets the presence of 1's and 0's on each of the three clock distribution lines 104, A, B, and C to a substantially uniform distribution, i.e., just as likely to see a 1 as a 0 on any one line. This assures that peak emissions are avoided on any one line of the three clock distribution lines 104, A, B, and C. Race conditions can be resolved with fixed or adjustable delay, length lines to lower arrival skew.

By converting the clocks to the frequency domain using a computed fast Fourier transform (FFT), it can be understood that the randomization of the clock sequences on the three clock distribution lines 104, A, B, and C radiate much less than a single clock line with a stable frequency.

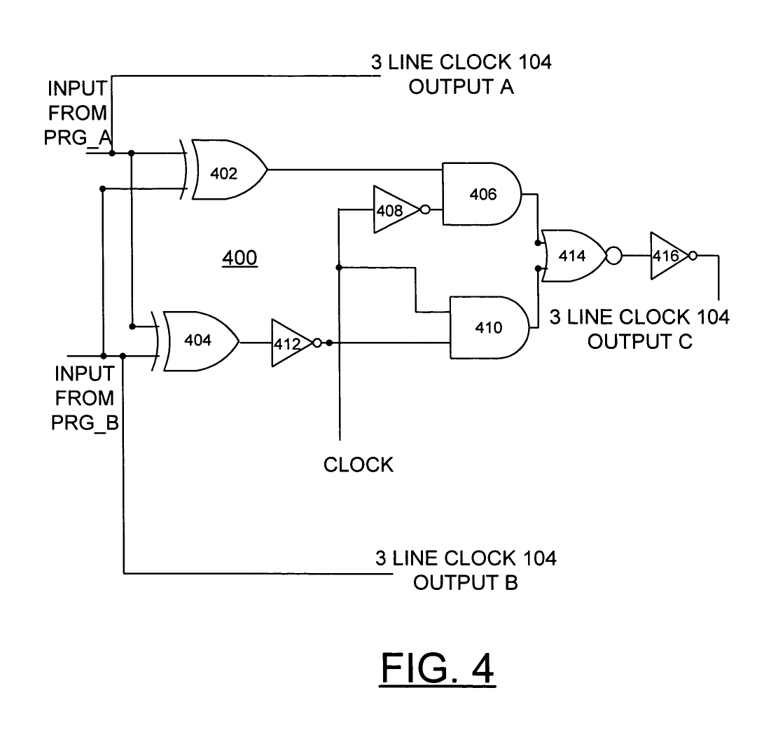

Referring now to FIG. 4, there is shown a schematic and block diagram illustrating an exemplary transmission hardware generally designated by the reference character 400 of a 3 line scrambled clock architecture 100. Transmission hardware 400 connects the received two pseudorandom generator (PRG) sequences output A, and output B labeled INPUT FROM PRG_A, INPUT FROM PRG_B straight through to the clock distribution lines 104, A, B and the output C is derived from the exclusive OR of the inputs PRG_A, PRG_B and selected for the 0 or 1 output table 112, 114 depending on the clock.

Transmission hardware 400 includes a pair of exclusive OR gates 402, 404 each respectively receiving the first two PRG output A, and output B. The output of exclusive OR gate 404 is applied to a first AND gate 406 and an inverter 408 provides an inverted clock signal to a second input of the AND gate 406. The clock signal is applied to an input of a second AND gate 410. The output of exclusive OR gate 404 is inverted by an inverter 412 and applied to the second AND gate 410. The outputs of the first and second AND gates 406, 410 are applied to a NOR gate 414. An inverter 416 connected to the output of NOR gate 414 provides the output C applied to the clock distribution line 104, C.

While the present invention has been described with reference to the details of the embodiments of the invention shown in the drawing, these details are not intended to limit the scope of the invention as claimed in the appended claims.

What is claimed is:

1. A method for implementing clock signals with lower electromagnetic emissions comprising:
receiving a clock input and generating a plurality of scrambled sequences, coupling said generated plurality of scrambled sequences by a plurality of N clock distribution lines to a destination circuit;
connecting an exclusive OR gate to the N clock distribution lines for unscrambling the plurality of scrambled sequences at the destination circuit to provide a clock output.

2. A method for implementing clock signals with lower electromagnetic emissions as recited in claim 1 wherein the steps of generating a plurality of scrambled sequences includes the steps of generating a plurality of scrambled sequences including multiple bit clock representations.

3. A method for implementing clock signals with lower electromagnetic emissions as recited in claim 1 wherein the steps of generating a plurality of scrambled sequences includes the steps of generating a plurality of scrambled sequences including a substantially uniform distribution of 1s and 0s on each of said plurality of N clock distribution lines.

4. A method for implementing clock signals with lower electromagnetic emissions as recited in claim 1 wherein the steps of generating a plurality of scrambled sequences includes the steps of generating a plurality of generally pseudorandom sequences.

5. A method for implementing clock signals with lower electromagnetic emissions as recited in claim 1 wherein the steps of coupling said generated plurality of scrambled sequences by a plurality of N clock distribution lines to a destination circuit includes the steps of coupling said generated plurality of scrambled sequences by three clock distribution lines to a destination circuit.

6. A method for implementing clock signals with lower electromagnetic emissions as recited in claim 1 wherein the step of receiving a clock input includes the steps of receiving a single phase clock.

7. A method for implementing clock signals with lower electromagnetic emissions as recited in claim 6 wherein the steps of generating a plurality of scrambled sequences includes the steps of selecting one of a plurality of valid states of a 1 table and a 0 table.

8. A method for implementing clock signals with lower electromagnetic emissions as recited in claim 6 wherein the steps of generating a plurality of scrambled sequences includes the steps of using said received single phase clock for selecting said 1 table or said 0 table.

9. A multiple line scrambled clock architecture with random state selection for implementing clock signals with lower electromagnetic emissions comprising:
a clock distribution circuit for receiving a clock input and for generating a plurality of scrambled sequences,
a plurality of N clock distribution lines for respectively coupling said generated plurality of scrambled sequences to a destination circuit; and
an exclusive OR connected to said N clock distribution lines for unscrambling said plurality of scrambled sequences at the destination circuit to provide a clock output.

10. A multiple line scrambled clock architecture as recited in claim 9 wherein said clock distribution circuit includes a pseudorandom sequence generator for generating said plurality of scrambled sequences including a plurality of generally pseudorandom sequences.

11. A multiple line scrambled clock architecture as recited in claim 9 wherein said clock distribution circuit generates said plurality of scrambled sequences including multiple bit clock representations.

12. A multiple line scrambled clock architecture as recited in claim 9 wherein said clock distribution circuit generates said plurality of scrambled sequences including three bit clock representations.

13. A multiple line scrambled clock architecture as recited in claim 9 wherein said clock distribution circuit generates said plurality of scrambled sequences including a substantially uniform distribution of 1s and 0s on each of said plurality of N clock distribution lines.

14. A multiple line scrambled clock architecture as recited in claim 9 wherein said plurality of N clock distribution lines includes three clock distribution lines.

15. A multiple line scrambled clock architecture as recited in claim 9 wherein said clock distribution circuit includes a two output line, independent m(2) sequence generator coupled to a 0 table and a 1 table; each of said 0 table and said 1 table including a plurality of valid states.

16. A multiple line scrambled clock architecture as recited in claim 15 wherein said plurality of valid states include multiple bit clock representations.

17. A multiple line scrambled clock architecture as recited in claim 15 wherein said clock input is applied to said two output line, independent m(2) sequence generator.

18. A multiple line scrambled clock architecture as recited in claim 15 wherein said clock input is used for selecting said 1 table or said 0 table.
